(19) United States
(12) Patent Application Publication
(10) Pub. No.: US 2005/0196509 A1
(43) Pub. Date: Sep. 8, 2005

(54) Cheese for cooking in the microwave

(75) Inventor: Kevin Murphy, Lakewood, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Leprino Foods Company, Denver, CO (US)

(21) Appl. No.: 10/795,124

(22) Filed: Mar. 5, 2004

(51) Int. Cl. A23C 19/00

(52) U.S. Cl. 426/582

(57) ABSTRACT

Cheeses are provided that have good melt down performance in high heat applications (e.g., in microwaves). The cheeses contain one or more melt restriction agents to prevent the fat, protein and water present in the cheese from separating during high heat applications. The cheeses also optionally one or more other additives to tailor the performance, nutritional or other characteristics of the cheese. Methods for preparing such cheeses and methods of cooking food products containing the cheeses are also disclosed.

### FIELD OF THE INVENTION

This invention relates to cheeses that contain one or more melt restriction agents that give the cheeses acceptable melt down characteristics when used in high heat applications such as microwave cooking. The invention also relates to methods of preparing and cooking foods that contain such cheeses and the products that result from such methods.

### BACKGROUND OF THE INVENTION

A major trend in the food industry has been the increase in demand for convenience food products that require minimal preparation before they are ready to eat. Often such foods simply need to be heated before they can be served. One approach that the food industry has taken to satisfy this demand is to prepare food products that can be heated in microwaves, thereby reducing the time required to heat the product. Another trend has been the increasing use of various types of cheeses in convenience foods.

In view of the concurrent demand for convenience foods that can be heated in a microwave and for foods that contain cheeses, there is a need for cheese-based products that can be prepared in a microwave, or under similar cooking conditions characterized by the application of high heat for relatively short time periods (e.g., 0.5-10 minutes). There are challenges, however, in preparing a cheese that has the desired performance characteristics with respect to melt, stretch, and browning/blistering when heated in a microwave. These challenges arise, at least in part, because the basic principle of heating in a microwave oven differs significantly from that in a conventional gas or electric oven. With a conventional gas or electric oven, the oven chamber is heated and the food positioned therein is heated and cooked by the inward conduction of that heat. When a food product is cooked in a conventional oven, the heat flows slowly from the surface into the center of the food. The last part of the food product to become hot is its center and the surface tends to be drier and cooked more thoroughly than the center. In microwave cooking, in contrast, the radio waves (microwaves) penetrate the food and excite primarily water molecules in the food, such that the water heats more rapidly than other components (e.g., protein and fat) of the food. The air around the food also remains substantially unheated and the surface of the food is not appreciably hotter than the interior.

Because the primary components of cheese (protein, fat and water) are not simultaneously heated in microwaves, it is difficult to formulate a cheese with the desired melt down characteristics, more specifically a cheese in which the protein, fat and water do not separate and the cheese melts to form a uniform mass. With many cheeses, microwave cooking causes the major components of the cheese to separate such that the cheese melts too much, resulting in a thin and broken-down appearance on the food product that is undesirable to consumers. This over-melting causes the amount of cheese to appear insufficient or even non-existent, or to flow off the food item. There thus remains a need for cheeses that exhibit desirable melt characteristics during microwave and other high-heat, short-time cooking methods.

### BRIEF SUMMARY OF THE INVENTION

Cheeses of various types (e.g., traditional, analogs, blends, processed cheeses) are provided that give good melt down performance in cooking conditions that involve the application of high heat for relatively short period of times, such as in microwave, infrared and steam heating applications. Methods for preparing cheeses that have such characteristics and methods of cooking products that include these type of cheeses are also described. Food products that include such cheeses are also provided.

Some of the cheeses that are provided that are suitable for use in the aforementioned cooking applications have a protein content of about 15-40 wt. %, a fat content of about 10-50 wt. % on a dry basis, and a water content of about 45-60 wt % and comprise one or melt restriction agents selected from the group consisting of a starch, a cellulose agent, a gum, a calcium agent and a phosphate salt. The melt restriction agents are present in a sufficient amount such that the cheese has acceptable melt down characteristics when heated in a microwave. In some instances, the one or more melt restriction agents are present in an amount sufficient to prevent separation of the protein, fat and water present in the cheese when heated in a microwave at a high setting in a 650-850 watt microwave for up to about 10 minutes. Certain cheeses include at least a cellulose agent or a calcium agent as a melt restriction agent. The cheeses that are provided can also optionally include one or more additives to further tailor the appearance, taste or performance characteristics of the cheese. These additives are generally selected from the group consisting of a stabilizer, a colorant, a dairy solid, a cheese powder, a flavor and a non-dairy protein isolate.

The cheeses that are disclosed herein can be prepared by a variety of processes. Some processes, for instance, generally involve incorporating one or more melt restriction agents into the cheese, the one or more melt restriction agents selected from the group consisting of a starch, a cellulose agent, a gum, a calcium agent and a phosphate salt.

Some methods are useful in the preparation of soft or semi soft cheeses. Certain of these methods, for example, involve 1) providing an admixture that comprises a heated mass of mozzarella variety cheese and one or more melt restriction agents, and 2) shaping and cooling the admixture to form the soft or semi-soft cheese. As noted above, the melt restriction agents are typically selected from the group consisting of a starch, a cellulose agent, a gum, a calcium agent and a phosphate salt, and are present in an amount sufficient such that the cheese has acceptable melt down characteristics when heated in a microwave. In some methods, the providing process involves providing a heated mass of soft or semi-soft cheese and mixing the one or more melt restriction agents into the mass to form the admixture. In other methods, however, the providing process involves (i) mixing the one or more melt restriction agents with a cheese curd, and (ii) heating and kneading the mixture of curd and one or more melt restriction agents to form the admixture.

The cheeses and food products containing the cheeses that are provided can be cooked in a variety of ways. Some methods initially involve providing a food product that comprises a cheese, wherein the cheese has a protein content of about 15-40 wt. %, a fat content of about 10-50 wt. % on a dry basis, and a water content of about 45-60 wt % and comprises one or more melt restriction agents selected from the group consisting of a starch, a cellulose agent, a gum, a calcium agent and a phosphate salt. The food product is then exposed to microwave energy in an amount and for a duration sufficient to heat and melt the cheese, whereby the cheese melts to form a uniform mass of cheese.

A variety of food products that include the cheeses that are disclosed herein are also provided. The cheese can be incorporated into a variety of food stuffs such as frozen pizzas, burritos, enchiladas, enrobed sandwiches and breaded cheese sticks. Methods for providing such food products are also disclosed. These processes generally involve combining a food stuff with a quantity of a cheese such as provided herein.

### BRIEF DESCRIPTION OF THE DRAWINGS

FIG. 1 is a schematic representation of an exemplary system that can be used to prepare certain cheeses that are disclosed herein.

FIG. 2 is a diagram summarizing one example of a process for preparing certain cheeses that are disclosed herein.

FIG. 3 is a diagram summarizing a second example of a process for preparing certain cheeses that are disclosed herein.

FIG. 4 is a diagram summarizing one example a method for cooking certain food products that contain a cheese such as provided herein.

FIGS. 5A-D show the melt down characteristics of a standard mozzarella cheese as compared to a mozzarella cheese including 2 wt. % starch. FIGS. 5A and B, respectively, show a diced sample of a standard mozzarella cheese without any added melt restriction agents and a mozzarella cheese including 2 wt. % starch prior to heating in a microwave.

FIGS. 5C and D, respectively, show the standard mozzarella cheese and the mozzarella cheese with the added starch after heating in a microwave at a high setting for 2 minutes. As can be seen, the cheese with the added melt restriction agent gave much better melt down performance.

### DETAILED DESCRIPTION OF THE INVENTION

I. Overview

A variety of cheeses are provided that are suitable for use in microwaves and other applications involving high heat and short cooking conditions, such as encountered, for example, in infrared, convection and steam cooking. These cheeses include various melt restriction agents, which include, for example, water binding agents and protein cross-linking agents. Incorporation of these agents inhibits the breakdown and separation of the cheese into its major component parts during heating conditions, which can be problematic with many existing cheeses. These agents thus promote acceptable melt down of the cheese during high heat cooking conditions, such that the cheese melts to form a uniform mass upon heating.

Methods for making cheeses with the desired melt characteristics are also provided. Methods for making food products containing these cheeses and products containing such cheeses are also provided. Methods of cooking the disclosed products to obtain a heated product in which the cheese is evenly melted are also described.

II. Cheeses Suitable for Microwave Use

A. General Characteristics

The cheeses that are provided can be of a variety of types but include one or more melt restriction agents that give the cheese good melt down characteristics, even when heated in a microwave. The cheeses can also include one or more GRAS (Generally Recognized As Safe) additives to further tailor the taste, appearance and performance characteristics of the cheeses. The cheeses can be natural, analog (including, e.g., imitation and substitute cheeses), blended cheeses (e.g., blends of soft or semi-soft cheeses and an analog cheese) or processed cheeses.

“Natural cheeses” include, but are not limited to, hard cheeses and soft or semi-soft cheeses, which can include fibrous cheeses. Hard cheeses include, but are not limited to, parmesan and Romano cheeses. “Soft or semi-soft fibrous cheese” includes, for example, mozzarella, cheddar, Monterey Jack and provolone cheeses. The mozzarella cheese can be a fibrous cheese which refers to a cheese that is subjected to a process to improve the stretchability or stringiness of the cheese. In the processing of such soft or semi-soft cheeses, the cheese curd is heated and kneaded until it is a homogeneous, fibrous mass of heated, unripened cheese. This unripened cheese is then formed into the desired shape and cooled (e.g., by floating the formed cheese in cold brine). This process and related processes are sometimes referred to as a pasta filata process of manufacturing. Cheeses made by this process are known under a variety of names, including mozzarella, pasta filata, provolone, scamorze, and pizza cheese.

“Analog cheeses” (or cheese analogs) constitute a second major category of cheese that is provided. Analog cheese generally refers to a cheese in which a fat and/or protein source has been substituted for a source that is native to milk. Cheese analogues can be further categorized as dairy, partial dairy, or nondairy, depending on whether the fat and/or dairy components are from dairy or vegetable sources. They can also be classified as being an imitation cheese or a substitute cheese. “Imitation cheese” is a substitute for and resembles another cheese but is nutritionally inferior to that cheese. A ∂cheese substitute,” on the other hand, resembles another cheese but is not nutritionally inferior to that cheese. Analog cheeses also typically contain casein, a vegetable oil, and/or an emulsifying agent. Fats, starches, acids and flavoring agents are also sometimes included.

The cheeses that are provided can also be blended cheeses that are a blend of two or more types of cheese. For example, one type of blended cheese that is provided is a “soft or semi-soft cheese and analog cheese blend,” which, as the name implies, includes a combination of a soft or semi-soft cheese and an analog cheese.

In addition to inclusion of a melt restriction agent, some of the cheeses that are provided (e.g., some of the soft or semi-soft cheeses) also have the following characteristics: a protein concentration of about 15-40 wt. %, a fat concentration of about 10-50 wt. % on a dry basis, and a water content of about 45-60%. The cheeses can also optionally contain one or more GRAS additives. Both the melt restriction agents and the GRAS additives are described in greater detail below.

The melt restriction agents are present in the cheeses in a sufficient or effective amount such that the cheeses are suitable for use in heating conditions that involve the application of high heat for relatively short periods of time, such as associated with microwave cooking and certain infrared, convection and steam cooking applications. The melt restriction agents are present in an a “sufficient amount” or an “effective amount” if the cheese exhibits acceptable melt down performance when heated by one of the foregoing types of heating for a standard cooking period.

“Acceptable melt down performance,” can be defined according to a number of readily observable parameters. Melt down performance, for example, is generally deemed acceptable if the primary components of the cheese (protein, fat and water) do not become separated during the standard cooking period. The phrase “standard cooking period” generally refers to the time period typically required to heat a refrigerated or frozen convenience food using a high heat (e.g., microwave, infrared or convection cooking). Typically, such time periods are up to about 20 minutes, or up to about 15 minutes, or up to about 10 minutes, more specifically for about 0.5-10 minutes, about 1-8 minutes, about 2-8 minutes or about 3-6 minutes.

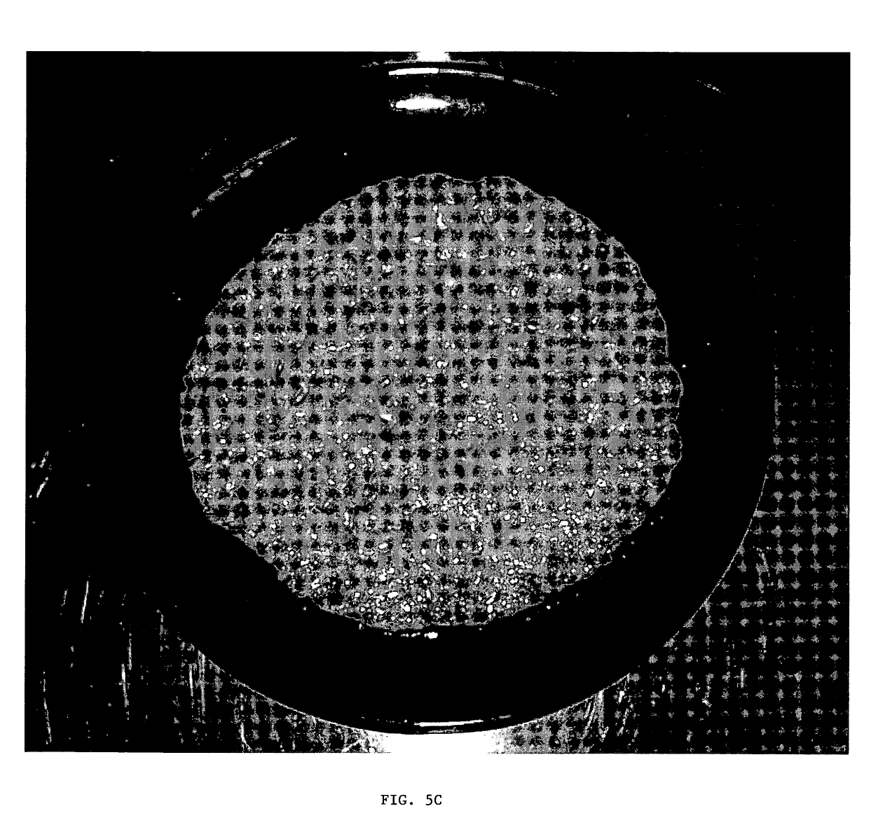

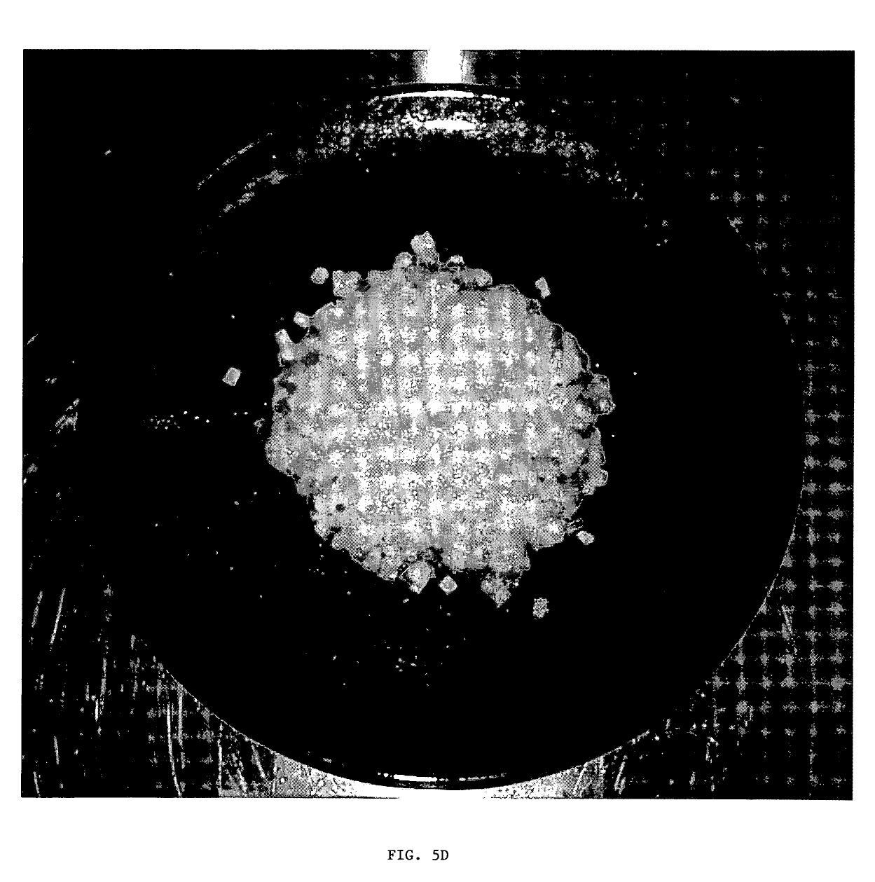

the case of microwave heating applications, for example, melt restriction agents are present in a sufficient or effective amount if present at sufficiently high levels to inhibit or prevent protein, water and fat in the cheese from separating when heated at a high setting in a 650-850 watt microwave for a standard cooking period (e.g., for about 0.5-10 minutes, or about 2-5 minutes). In some applications, the melt restriction agent is present in a sufficient amount such that when the cheese is heated in a microwave with a 850 watt power rating at the high setting for two minutes individual pieces of a comminuted cheese melt together to form a homogeneous mass of cheese without excess flow (see, e.g., FIG. 5D).

The term “separation” or “separating” as used in this context is not meant to refer to the normal evaporation of some of the water present in the cheese during the heating process, but rather to a more extensive separation that occurs when a cheese is over melted. This is evidenced, for example, by the melted cheese exhibiting a thin or broken down appearance on a food product, or when the cheese melts to such an extent that it disappears into the food product (e.g., down into the toppings on a pizza) or flows off the food product during the standard cooking period.

Stated in positive terms, acceptable melt down performance is evidenced, for example, when the individual cheese pieces present in food products containing comminuted cheese melt together to form a uniform mass of cheese upon heating. Once melted, the cheese also typically retains good stretch and is slightly to moderately chewy when eaten.

As indicated above, the cheeses that are provided in general have a protein content of about 15-40 wt. %, a moisture content of about 45-60%, and a fat content of about 10-50% on a dry basis (FDB). The actual composition varies somewhat depending upon the particular type of cheese that is to be produced. For certain mozzarella type cheeses that are provided, for instance, the milk fat content is at least 45% by weight of solids and the moisture content is about 52-60 wt. %. The low-moisture mozzarella cheeses that are provided generally have a minimum milk fat content of 45% by weight of solids and a moisture content that is about 45-52 wt. %. Part skim-milk mozzarella cheeses that are provided, in contrast, have a milk fat content that ranges from about 30-45% by weight of solids and a moisture content that is about 45-60 wt %. The low-moisture, part-skim mozzarella cheeses that are provided usually have a milk fat content of about 30-45% by weight of the solids and a moisture content of about 45-52 wt %. The foregoing moisture percentages are for bound plus free water, i.e., the percent of weight lost when the cheese is dried overnight in a 200° C. oven.

The cheeses that are provided can be in a variety of different forms including loaves, ribbons, comminuted forms (e.g., diced or shredded forms) and other forms known in the art. The pH of the cheese generally ranges from about 5.00 to about 6.00, such as about 5.00 to about 5.50.

B. Melt Restriction Agents

The melt restriction agents that are incorporated into the cheeses generally fall into two general classes: agents that bind water and agents that promote interactions between proteins (e.g., cross-linking or aggregation). Water-binding melt restriction agents typically are selected from the group consisting of a starch, a cellulose agent, and a gum/stabilizing agent. Cross-linking agents are selected from calcium agents (e.g., a calcium salt), phosphate salts and enzymes that promote cross-linking (e.g., transglutaminases). Certain cheeses contain at least a cellulose agent and/or a calcium agent. Some of the cheeses lack an emulsifying agent. As used herein the term “emulsifying agent” refers generally to agents that are also known in the art as sequestrants, particularly those that sequester calcium. An emulsifying agent may be omitted so as not to negate the effect of any calcium agents that are included in the cheese.

On a weight basis, the combined amount of the melt restriction agent(s) generally account for up to 1, 2, 4, 5, 6, 8 or 10% of the finished cheese by weight. The melt restriction agents thus typically make up about 1-10%, about 2-10%, or about 4-10% of the cheese by weight. Unless specified otherwise, the weight percentages that are listed herein for the melt restriction agents are expressed relative to the finished cheese after it has been fully processed, i.e., after the agents and other optional additives have been added and the cheese has been sized, shaped and cooled (these steps are discussed more fully in the section on producing the cheese below). Additional details regarding the type and amount of the melt restriction agents are set forth below.

1. Water Binding Agents

As noted above, one class of melt restriction agents that can be combined with the cheese are those that bind water. Suitable agents within this category include, but are not limited to, starches, celluloses, gums and stabilizing agents. Agents in this category can be incorporated into the cheese individually or in combination.

A number of different types of starches can be utilized as melt restriction agents. Suitable starches include vegetable starches (e.g., potato starch, pea starch, and tapioca) and grain starches (e.g., corn starch, wheat starch, and rice starch). Specific examples of suitable corn starches include dent corn starch, waxy corn starch, and high amylose corn starch. The starches can be used individually or in combination.

The starch can be modified or native. Modified food starches differ in their degree of cross-linking, type of chemical substitution, oxidation level, degree of molecular scission, and ratio of amylose to amylopectin. Examples of some commercially-available modified food starches that are suitable include Mira-Cleer 516, Pencling 200, Purity 660, Batterbind SC, Penbind 100, and MiraQuick MGL. A suitable commercially-available native (unmodified) starch is Hylon V.

Mira-Cleer 516, from A. E. Staley Company, is a dent corn starch that is cross-linked and substituted with hydroxypropyl groups. The cross-linking increases its gelatinization temperature and acid tolerance. The hydroxypropyl substitution increases its water binding capability, viscosity and freeze-thaw stability. MiraQuick MGL, also from A. E. Staley Company, is an acid-thinned potato starch. The acid thinning breaks amylopectin branches in the starch, creating a firmer gel. Batterbind SC, from National Starch, is a cross-linked and oxidized dent corn starch. Purity 660, also from National Starch, is a cross-linked and hydroxypropyl substituted dent corn starch. Hylon V, also from National Starch, is an unmodified, high amylose corn starch.

Pencling 200, from Penwest Foods, is an oxidized potato starch. The oxidation increases its capacity to bind water and protein. Penbind 100, also from Penwest Foods, is a cross-linked potato starch.

If used as a melt restriction agent, starches typically are added at a level up to about 1, 2, 4, 5, 6, 8 or 10% by weight. The starch levels can thus vary from about 0.5-10%, from about 1-10%, from about 2-10%, from about 4-8%, or from about 1-4%. Starches are normally added as dry ingredients rather than as a solution.

Different types of celluloses can also be incorporated into the cheese as melt restriction agent. The cellulose can be either natural or modified. One cellulose or combinations of different celluloses can be utilized. Types of celluloses that can be utilized include, but are not limited to, native cellulose powders or modified celluloses. One specific example of a commercially available modified cellulose is METHOCEL A-15™ that is available from Dow Chemical Company.

When included in the cheese, the cellulose level typically is up to about 0.25%, about 0.50%, about 1%, about 5% or about 10% by weight. More specifically, the amount of cellulose can range from about 0.1-10%, from about 0.25-10%, from about 0.5-10%, or from about 1-10% by weight.

Gums or stabilizers of different types can also be utilized as melt restriction agents. Examples of suitable gums include, but are not limited to, xanthan gum, guar gum, and locust bean gum. Examples of suitable stabilizers include chondrus extract (carrageenan), pectin, gelatin, and agar.

The total amount of gums and stabilizers included in the cheese is typically up to about 0.5%, about 1.0%, about 2.0%, about 5%, or about 10% by weight. More specifically, the amount of gums and/or stabilizers can range from about 0.5-10%, from about 1-10%, from about 2-10%, or from about 5-10% by weight. Gums and stabilizers are typically added in the dry form, rather than pre-mixed with water.

2. Cross-Linking Agents

A second class of agents that can be incorporated into the cheese as melt restriction agents are those that promote protein cross-linking or other types of protein-protein interactions or aggregation. Agents of this type include, but are not limited to, calcium agents, phosphate agents and various cross-linking enzymes. Agents in this class can be added singly or in combination.

Calcium agents of various types can be included in the cheese. Typically, these agents are inorganic salts, but other types of calcium agents can also be used. Examples of suitable calcium salts include calcium chloride, calcium phosphate, calcium carbonate, and calcium sulfate. These agents are typically added as part of a solution.

The total amount of calcium agents incorporated in the cheese is generally up to about 0.01%, 0.5%, 1.0% or 2.0% by weight. More specifically, the amount of calcium agents can range from about 0.1-2.0%, from about 0.5-2.0%, or from about 1.0-2.0% by weight.

A number of different phosphate salts can be added to the cheese as melt restriction agents. Phosphate salts that can be utilized include, but are not limited to, sodium hexametaphosphate, monosodium phosphate, sodium tripolyphosphate, disodium phosphate, and trisodium phosphate. The total amount of phosphate salt incorporated in the cheese is generally up to about 0.01%, 0.50%, 1.0% or 2.0% by weight. More specifically, the amount of phosphate salts can range from about 0.1-2.0%, from about 0.5-2.0%, or from about 1.0-2.0% by weight.

Another option is to include an enzyme that promotes promotes protein cross-linking. Suitable enzymes include transglutaminases. The amount of enzyme added typically ranges from about 0.01-1.0 wt. %.

C. Other Optional Additives

In addition to the foregoing melt restriction agents, various GRAS food additives can also optionally be incorporated into the mozzarella cheeses that are provided. As described in greater detail below, these optional additives include, but are not limited to, an acid, a cheese powder, a colorant, a dairy solid, a flavoring agent, a non-dairy protein isolate and sodium chloride. The percentages listed below unless otherwise indicated are weight percentages expressed relative to the weight of the final cheese product.

An acidic agent (an acid) can be incorporated into the heated cheese to adjust the pH of the finished cheese to a desired level. The acidity of the cheese can be controlled to help regulate the melt down characteristics of the finished cheese. Various acids can be employed; examples of suitable acids include, but are not limited to, adipic acid, lactic acid, hydrochloric acid, acetic acid, or Genlac C, the latter being a blend of water, citric acid, lactic acid, acetic acid and artificial flavors. Acid is typically added to adjust the pH of the finished cheese to a pH from about 5-6, and more typically from pH 5.00-5.50.

Cheese powders can also be mixed into the cheese to impart a different cheese flavor to the finished product. Examples of suitable cheese powders include, but are not limited to, Parmesan, cheddar, Monterey Jack, Romano, muenster, Swiss, and provolone powders. The amount of cheese powder in the finished cheese is generally about 0.25 to 10%, and in some instances about 0.25 to 1% by weight. Typically, cheese powders are mixed into the cheese as a dry powder. Cheese powders are available from a variety of commercial suppliers, including, for example, Armour Foods of Springfield, Ky.

A colorant can be incorporated into the cheese to adjust its natural color. This can be useful, for example, if consumers have a preference for a color other than the naturally-occurring color. The amount of colorant added is typically in the range of about 0.001 to 2%, or 0.01-2% based on the weight of the finished cheese. Examples of suitable colorants include annatto, tumeric, titanium dioxide, and beta-carotene. Tumeric, for example, imparts a yellowish color to mozzarella, which naturally is white. The yellowish color often is preferred by consumers who perceive it to indicate a “richer” product upon cooking on a pizza. Tumeric, if used, is generally added in an amount of about 0.05 to 0.2%. One suitable source of tumeric is Chris Hansens Labs of Milwaukee, Wis. Colorants typically are added as a solution or as a dispersion in water.

Annatto is useful to give mozzarella cheese the appearance of cheddar. This allows one to produce a cheese for pizza baking that has the desired melt characteristics of mozzarella, but with a different appearance than that of traditional white mozzarella. Annatto-colored mozzarella can be used as a replacement for cheddar cheese in many food products (e.g., Mexican-style prepared foods). If annatto is added, it normally is added to about 0.001-0.3%, or 0.1 to 0.3% by weight. Chris Hansen Labs are also a suitable source of annatto.

A dairy solid can be added to firm the cheese, further improve water binding capacity, improve the melt appearance of the cooked cheese, and/or increase the blistering of the cooked cheese. Dairy solids that can be utilized include, but are not limited to, whey protein concentrate, casein hydrolyzate, milk fat, lactalbumin, and nonfat dry milk. Dairy solids generally are included in an amount within the range of about 0.1 to 10%, based on the weight of the finished cheese. Usually the dairy solid is added to the heated cheese in dry form, although it can also be added after being pre-mixed with water.

Various flavoring agents can also be incorporated into the cheese to tailor the flavor profile of the cheese to meet consumer preferences. Suitable flavors for mixing into the heated cheese include, for example, cheddar cheese flavor and parmesan cheese flavor. Flavoring agents are typically added in an amount within the range of about 0.01 to 5%, based on the weight of the finished cheese. Although flavoring agents can be added in dry powdered form, usually the flavoring agent is added to the heated cheese in the form of an aqueous solution. Typically the solution will contain about 5 to 50 wt. % of the flavor, e.g., about 20 to 40%.

A non-dairy protein isolate can also be incorporated into the cheese. It is added to alter the texture of the cheese and/or to change the size, color, or integrity of the blisters that are formed when the cheese is baked on a pizza, as well as other cook characteristics. Examples of suitable non-dairy protein isolates include, but are not limited to, soy protein (sometimes called “soy powder”), gelatin, wheat germ, corn germ, gluten, and egg solids. The amount of non-dairy protein isolate incorporated into the cheese generally falls within the range of about 0.1 to 10% by weight. A non-dairy protein isolate, if added, is typically added as a powdered solid.

Salt, i.e., sodium chloride, can be added to the heated cheese to tailor the flavor of the final cheese. Although salt can be added in the form of an aqueous solution, generally the salt is added in granular form. If used, the salt is typically added at a level of about 0.1 to 5 percent, based on the weight of the finished cheese.

D. Analog Cheese Ingredients

If the cheese is an analog cheese or blended cheese that includes an analog cheese, in addition to the foregoing melt restriction agents and optional additives, the cheese also includes the basic ingredients for an analog cheese. The analog cheese ingredients most commonly incorporated into the cheese include water, a casein, a vegetable oil, and/or an emulsifying agent. All of these ingredients, however, may not be required for all cheeses. Other ingredients that are sometimes incorporated include a fat and an acid. These analog cheese ingredients are described more fully below.

Different forms of casein can be incorporated into the cheeses that are described herein, but in general are tasteless, odorless, and noncrystalline. Suitable caseins include, for example, but are not limited to, acid caseins, rennin caseins, neutral caseins and sodium and calcium caseinates. Examples of acid caseins include lactic acid casein, hydrochloric acid casein and sulfuric acid casein.

The vegetable oil component can be of any edible type. The preferred kind of vegetable oil is one with a bland flavor that has physical characteristics similar to those of butter fat. Suitable vegetable oils include, but are not limited to, safflower seed oil, corn oil, soybean and mixtures of one or more of these oils.

The fat included in the cheese can be any relatively low melting point vegetable or animal fat, but preferably has essentially a bland taste and is a liquid at a temperature of less than 130° F. (melting point of less than 130° F.). In some instances, the melting point is between 20-130° F., e.g., between 40-125° F., or between 50-120° F. Vegetable fats such as those derived from coconuts, soybeans, safflower, corn and cotton are sometimes preferred because they are not as difficult to preserve such as some animal fats (e.g., butter fat).

A number of different emulsifying agents can be included to keep the various ingredients in solution. As indicated above, the term “emulsifying agent” is intended to include, but is not be limited to, the chemical agents sometimes referred to as sequestrants. If an emulsifying agent is used, it generally is one that sequesters calcium ions in the cheese (i.e., it reduces the degree to which the calcium is ionically bound to the protein in the cheese).

Calcium-binding emulsifying salts are sometimes used, particularly phosphates and citrates, with the sodium and sodium aluminum salts being the ones most typically used. Examples of suitable phosphates are sodium hexametaphosphate (SHMP), monosodium phosphate (MSP), sodium tripolyphosphate (STPP), and disodium phosphate (DSP). DSP is generally available in its hydrated form, disodium phosphate dihydrate. Sodium citrate is commonly used and is available in solid form as sodium citrate dihydrate.

E. Exemplary Cheeses

One specific example of certain cheeses that fit within the general cheese types discussed above are described in greater detail in Example 2 below. These cheeses had a moisture composition of 46.5-51.5%, a protein level of 17-25% protein, and a fat content of 37.0-43.0% on a dry basis. The cheese had 2% starch added to it to give the cheese good melting performance in the microwave. This cheese also had 2% non-fat dry milk, 0.50% natural dairy flavors, and 0.0025% annatto coloring added to give the cheese the desired visual and organoleptic attributes.

Other cheeses (e.g., a soft or semi-soft cheese) have a protein concentration of about 15-40 wt. %, a fat concentration of about 10-50 wt. % on a dry basis, and a water content of about 45-60%, and include 0.01-2.0 wt. % calcium agent (e.g., 0.5-2.0%, or 0.5-1.0% by weight) and/or 0.01-2.0 wt. % celluose agent (e.g., 0.5-2.0%, or 0.5-1.0% by weight). These cheeses also optionally include one or more of the additives listed above.

Still other cheeses include at least one water-binding melt restriction agent and at least one cross-linking melt restriction agents at the concentrations in the ranges listed above.

III. System for Preparing Microwavable Cheese

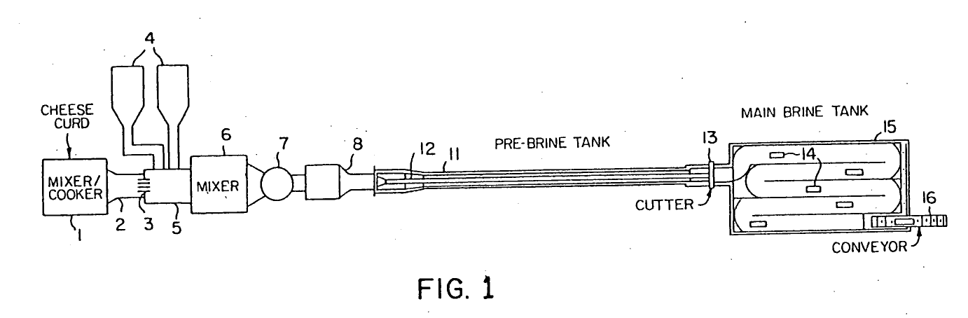

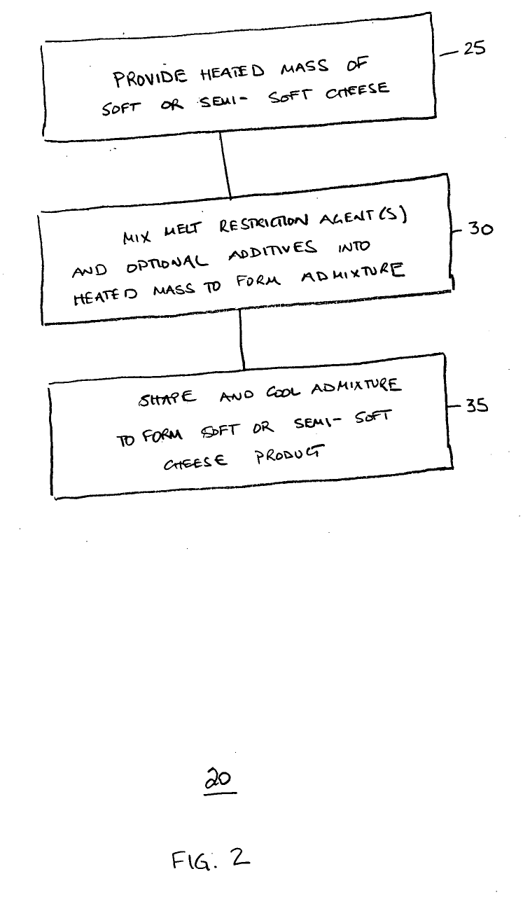

One specific example of a system that can be utilized for preparing a microwavable cheese (e.g., a soft or semi-soft cheese) having suitable melt characteristics is shown in FIG. 1. As illustrated in this figure, fermented cheese curd is introduced into mixer/cooker 1, where the curd is heated, kneaded and stretched to produce a homogeneous molten cheese mass. The resulting molten cheese mass is extruded through a transfer tube 2 to form an extruded ribbon of molten cheese. Slitters 3 form grooves in the extruded ribbon of molten cheese. The grooved, extruded ribbon is fed into an additional mixer 6, such as, e.g., a jacketed mixer having overlapping twin screw augers. Disposed between the slitters 3 and the additional mixer 6 is an inlet chamber 5 that enables liquid/dry ingredient applicators 4 to add one or more desired ingredients in either liquid or dry form into the ribbon grooves formed in the molten cheese by the slitters 3. The added ingredients are thoroughly mixed into the molten cheese mass by additional mixer 6. Positive pump 7 forces the resulting mixture through transfer tube 8 to form a continuous ribbon 12 of molten cheese. The extruded continuous ribbon 12 of molten cheese flows into pre-brine tank 11, such as a sodium chloride brine contained in pre-brine tank 11. Cutter 13 cuts the continuous ribbon 12 into cheese loaves 14 as the continuous ribbon 12 exits the pre-brine tank 11. The cooled, salted cheese loaves 14 float in main brine tank 15 until conveyor 16 removes the loaves 14 from the main brine tank 16. The loaves 14 may then undergo further processing as desired. As those of ordinary skill in the art will appreciate, various types of cooler besides pre-brine tank 11 and main brine tank 15 can be utilized to cool the heated cheese. Likewise, various types of cutters 13 can be utilized to form cheese of a variety of different shapes. Further discussion regarding related systems that can be utilized is provided in U.S. Pat. No. 5,902,625, which is incorporated herein by reference in its entirety for all purposes.

IV. Cheese Preparation Methods

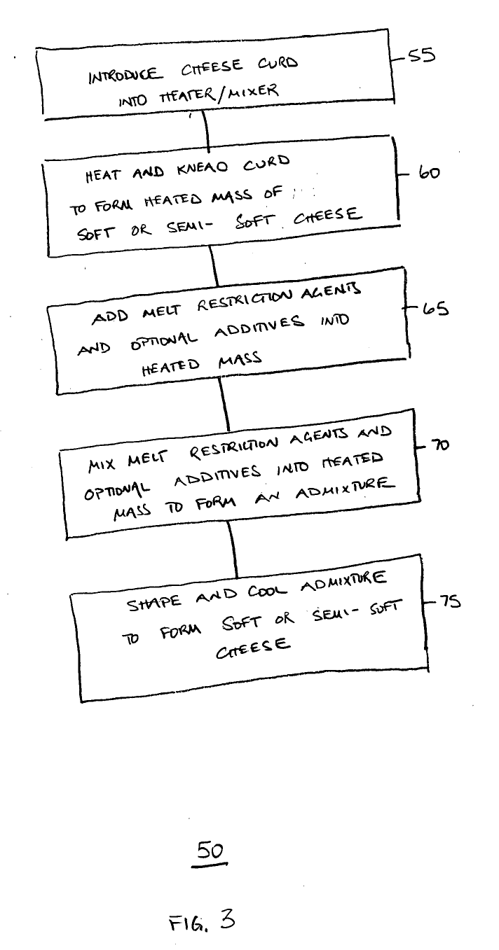

The cheeses that are provided can be prepared according to a variety of methods. The melt restriction agents (and optional additives) can be added at a number of different stages in the cheese preparation process. For example, in some instances, melt restriction agents and additives are added to the milk that is used to make the cheese curd, whereas in other instances they are added to the cheese curd before (or during) the heating and kneading of the curd during the pasta filata process (see discussion with respect to FIG. 2 below). Another option is to add the melt restriction agents and optional additives to the cheese as it is being shaped or extruded into a final product (see below). Still another option is to add the ingredients to the final cheese product (e.g., sprinkling or mixing the agents and additives with a diced or shredded cheese product).

General methods for making analog cheeses are reviewed, for example, by Bachmann, et al. (Intl. Dairy J. 11:505-515, 2001). Other specific approaches are discussed, for example, in U.S. Pat. Nos. 4,197,322; 4,822,623; and 4,397,926. These methods can be modified to include inclusion of the melt restriction and additives that are disclosed herein. In general, some methods involve blending together the basic ingredients for an analog cheese (e.g., water, fat, casein, vegetable oil and an emulsifying agent) with the melt restriction agents and optional additives.

One approach for making a blended cheese is to blend together the ingredients for an analog cheese, the melt restriction agents, optional additives, and a cheese curd (e.g., for a soft or semi-soft cheese) to form the blended cheese (e.g., blend of an analog and soft or, semi-soft cheese).

FIG. 2 illustrates one option for a method 20 of preparing a soft or semi-soft cheese (i.e., a mozzarella cheese) that is suitable for use in a microwave. Method 20 involves providing 25 a heated soft or semi-soft cheese mass and mixing 30 one or more of the melt restriction agents and optionally one or more of the additives into the heated mass to form an admixture. The resulting admixture is subsequently cooled 35 to form a soft or semi-soft cheese. The melt restriction agents are mixed into the heated mass in a sufficient amount such that the cheese has acceptable melt down characteristics when heated in a microwave. The other additives, if mixed in, are added such that the levels in the final cheese product are at the levels described above.

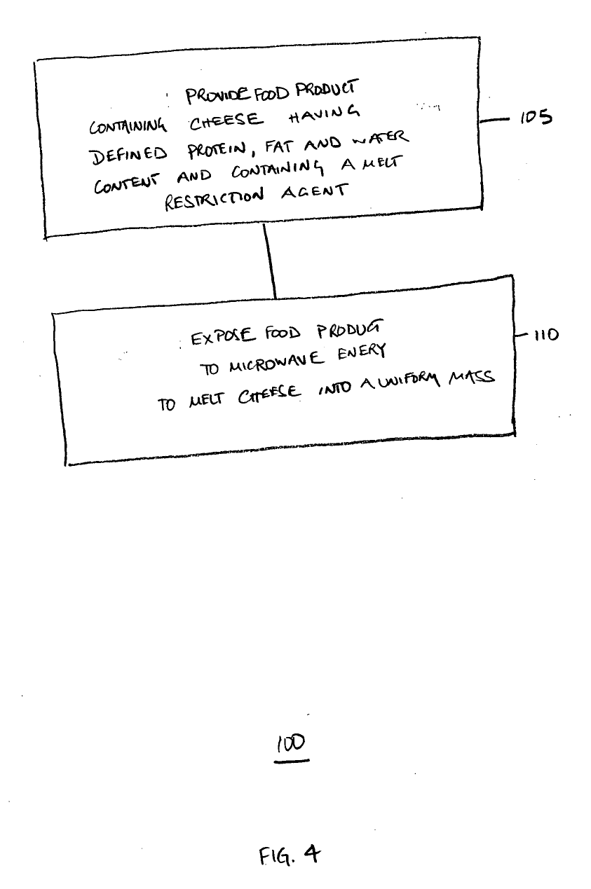

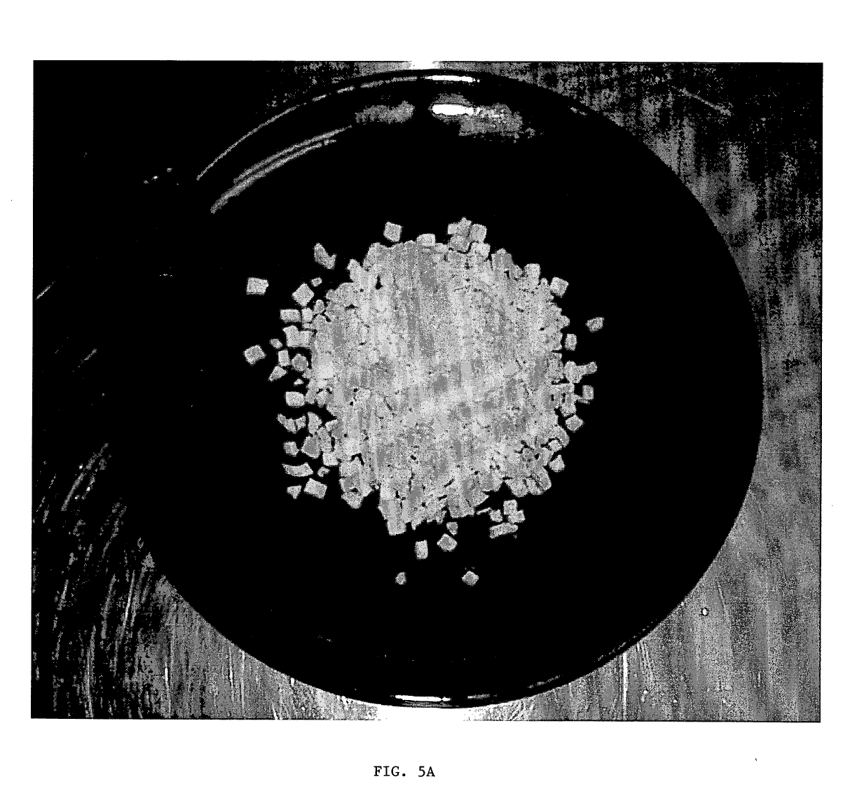

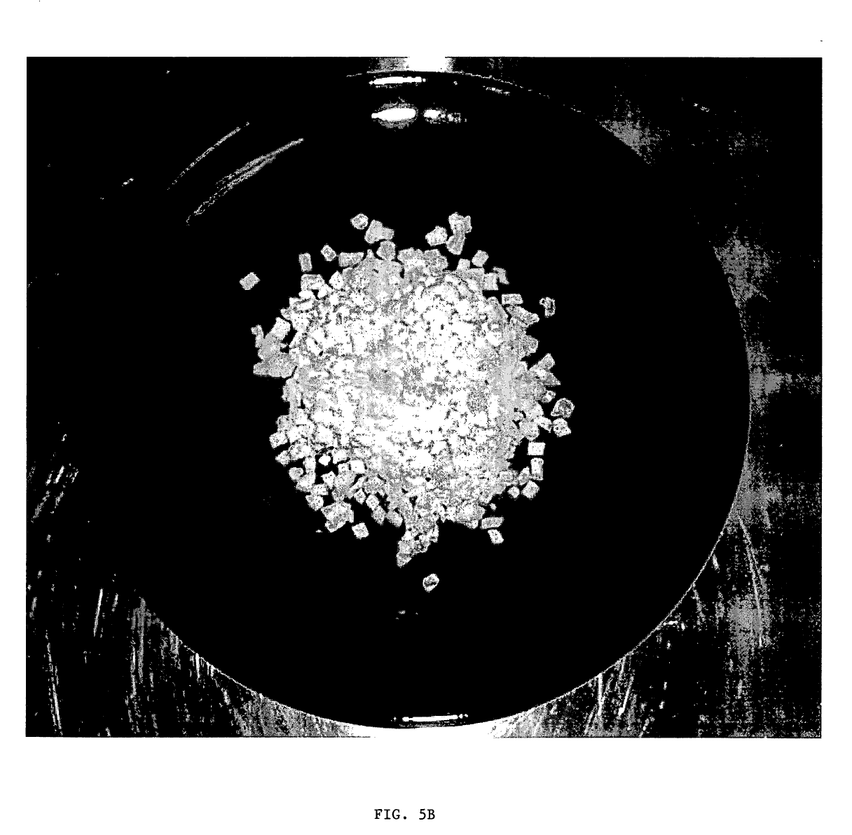

Some preparation methods utilize a system such as shown in FIG. 1. Method 50 is an example of one such method that uses such a system. As shown in FIG. 3, method 50 begins by introducing 55 a cheese curd into a mixer/cooker. The cheese curd is heated and kneaded 60 in mixer/cooker 1 at a temperature ranging from about 140 to about 160° F. until the cheese curd is converted into a homogeneous and fibrous mass of a soft or semi-soft fibrous cheese. In the inlet chamber 5, one or more melt restriction agents and optional additives are added 65 to the fibrous mass via liquid/dry applicators 4. The added ingredients and optional additives are subsequently mixed 70 into the mass in additional mixer 6 to form an admixture. This resulting admixture is then shaped and cooled 75 to form the final mozzarella cheese product. Further guidance on suitable preparation methods is provided in U.S. Pat. No. 5,902,625, which is incorporated herein by reference in its entirety.

Although method 50 involves the addition of the melt restriction agents and optional additives to the fibrous mass of cheese, as noted above, in other methods these agents and additives are added into the milk that is used to make the curd or with the curd before or during the time it is heated and kneaded. Or they can be added during the extruding process, or even to the final product.

The cheese curd that is introduced into mixer/cooker can be prepared from pasteurized cow's milk, buffalo milk or other milk source. The milk is acidified to form cheese milk. The acidification step can be performed either microbially or directly. Microbial acidification is accomplished by the addition of a starter culture of one or more lactic acid-producing bacteria to the milk, and then allowing the bacteria to grow and multiply. When making a mozzarella variety cheese, a bacterial starter culture composed of coccus, rods, or a combination of both is preferably used. Direct acidification is faster and is accomplished by the addition of a GRAS acid, such as, acetic acid (e.g., as vinegar), phosphoric acid, citric acid, lactic acid, hydrochloric acid, sulfuric acid, or glucono-delta-lactone (GdL) to the milk. Following acidification, the cheese milk is coagulated to form a coagulum that consists of cheese curd and whey. Rennet is typically added to the milk to enhance the coagulation activity. The resulting coagulum is cut and the whey drained off to obtain the cheese curd. The curd can optionally be scalded (cooked) for about 0.08 to 1.0 hours at about 30-48° C., at which point the curd is ready to undergo the heating and kneading operation.

As indicated above, the heating and kneading of the cheese curd is typically done in a piece of equipment called a mixer/cooker. One exemplary device for performing this operation is a single or twin-screw mixer or a twin-screw extruder, either fitted for steam injection or having a heated jacket, or a combination of both. When using a twin-screw mixer or extruder to perform the heating and kneading, the screws (i.e., augers) are typically arranged so they overlap, to insure thorough mixing.

The heating and kneading process is generally conducted under low shear conditions. Thus, for example, when using a twin-screw mixer having a ¼ inch clearance between the outer edge of each flight and the wall past which that edge moves, the speed of revolution of the screws will preferably be no more than about 50 rpm, e.g., in the range of about 12 to 40 rpm. Wider clearances can be used as well, e.g., up to, say ½ inch. The heating of the curd while it is being kneaded and stretched can be accomplished, for example, by conduction, through the wall of the kneading and stretching chamber, e.g., by use of a hot water jacket. In addition to, or instead of conductive heating, the contents of the extruder can be heated by releasing live steam into the kneading and stretching chamber. When live steam is used to heat the curd, the steam condensate is absorbed by the curd and forms part of the final mass of cheese. When using live steam in the mixer/cooker, typically the water content of the curd immediately prior to entering the mixer/cooker is about 45 to 55 wt. %, and sufficient steam is released into the kneading and stretching chamber such that the water content of the mass of cheese immediately after exiting the machine is up to about 5 percentage points higher, e.g., about 0.5 to 5 points higher. Often, it will be about 1.5 to 2.5 points higher. So, for example, if the water content of the curd entering the machine is 45 wt. %, then usually the amount of injected steam that is used to bring the curd up to the necessary temperature to obtain a homogenous, fibrous mass of cheese will be an amount that raises the water content to no more than about 47 wt. %.

Heating and kneading can be performed in the absence of any exogenous water. By “exogenous water” is meant water that is used to bathe the curd and which is subsequently separated from the homogenous cheese mass that is formed. A shortcoming of the use of exogenous water during the heating and kneading process is that, when the water is separated, valuable protein, fat, and other solids that otherwise would be bound up in the finished cheese are removed.

The cheese mass is generally at a temperature in the range of about 135 to about 165° F. (58-74° C.) when melt restriction agents and optional additives are added to it. The temperature in some applications is relatively high, such as between 160-165° F. In other methods, the temperature is at or slightly below that of pasteurization (65° C., 150° F.), for example in the range of about 145-150° F. (63-65° C.). The agents and optional additives can be added in solid and/or liquid form. Powdered solids can be added using any of a number of conventional approaches, including sprinkling the solids onto the cheese, usually across the entire surface of the cheese and typically after application of agents or additives in liquid form, if any. Liquid agents or additives can be sprayed down onto the surface of the cheese as it passes through the mixing chamber, usually in a spray that covers substantially the entire surface of the cheese. Mixing typically is for about 10-30 minutes, or about 15-25 minutes.

After the melt restriction agents and any optional additives have been added to the heated cheese, the agents and additives are mixed into the heated cheese mass using any mixing equipment that can thoroughly blend the agents and additives into the cheese. Examples of equipment that can be used, alone or in combination with other equipment, include an apparatus like those described, for example, in U.S. Pat. No. 5,902,625 to Barz; U.S. Pat. No. 4,682,538 to Zahlaus; U.S. Pat. No. 4,448,116 to Muzzarelli; U.S. Pat. No. 3,445,241 to Pontecorvo et al.; and U.S. Pat. No. 3,078,170 to Leber. Other apparatus that can be utilized are discussed in U.S. Pat. No. 4,902,523 to Fritchen et al., U.S. Pat. No. 4,592,274 to Tomatis, and U.S. Pat. No. 4,110,484 to Rule et al. Each of these patents are incorporated herein by reference in their entirety.

As one specific example, the cheese admixture that contains the melt restriction agents and any other additives is fed into a twin auger mixer, for example, to mix the agents and optional additive(s) into the heated cheese. In a twin auger mixer, the augers are generally arranged such that they overlap, thereby ensuring thorough mixing. The twin auger mixer can be jacketed, to keep the temperature of the cheese relatively constant. The thoroughly mixed cheese containing the melt restriction agents and optional additive(s) is then typically extruded into a cooler such as a brine tank.

The dwell time and rate of mixing of the admixture of cheese, melt restriction agents and optional additive(s) is adjusted to ensure that the agents and additives are completely mixed into the cheese mass. In general the dwell time in the mixer is in the range of about 10 to about 30 minutes. In some methods, for example, mixing continues for about 15 to about 25 minutes. Mixing in other instances is from about 20 to about 25 minutes. The mixer generally runs at a speed of 10-45 rpm. So, for example, in some instances, the mixer speed is 25-40 rpm; in other applications, the mixer speed is 10-25 rpm. As described in Example 1 below, mixing in certain applications is for about 18 minutes at a speed of about 18 rpm.

After incorporation of the melt restriction agent(s) and any optional additives into the heated cheese, the still-warm cheese (e.g., at a temperature in the range of about 135-165° F. (58-74° C.)) can be formed into any desired shape depending upon the ultimate intended use. In some instances, the admixture is extruded as a continuous ribbon, which is discharged into a cold sodium chloride brine channel or tank, for example as described in U.S. Pat. No. 4,339,468 to Kielsmeier or U.S. Pat. No. 5,200,216 to Barz et al. (both of which are incorporated herein in their entirety). The cheese ribbon is preferably contacted with cold sodium chloride brine (in one or more tanks or vessels) until its core temperature drops to about 75° F. (24° C.) or below. Then the cooled ribbon can be cut into segments having dimensions suitable for the intended use of the cheese.

If a string cheese is the desired product [e.g., a cheese having a diameter of about ¼ to ¾ inch (0.6 to 2 cm.)], the segments of the ribbon are generally about 1½ to 8 inches (4 to 20 cm) long. If the string cheese is to be baked only while enclosed in pizza crust (e.g., in a stuffed crust pizza), it typically is unnecessary to age the cheese before using it. If desired, the string cheese can be frozen and stored.

If the finished cheese is to be used as an exposed topping for a pizza, then the continuous ribbon, typically is rectangular in cross section, and can be cut into loaves, for example having a width of about 12 to 36 inches (30 to 91 cm.), a height of about ½ to 2 inches (1.3 to 5 cm.), and a length of about 14 to 24 inches (36 to 61 cm.). The loaves can then be further cooled in sodium chloride brine, for example to a core temperature in the range of about 28 to 45° F. (−2 to 7° C.), and then removed from the brine and comminuted, and the pieces individually quick frozen, for example by the process described in U.S. Pat. No. 5,030,470 to Kielsmeier, et al., which is hereby incorporated herein by reference.

Depending on the composition of the cheese, it may be preferable to store it for a time [e.g., about 7 to 21 days, at about 35 to 45° F. (2 to 7° C.)] after it is removed from the last brine tank and before it is comminuted and frozen. However, as described in U.S. Pat. No. 5,200,216 (Barz et al.), if the process is controlled such that the cooled cheese removed from the brine has a moisture content of about 45 to 60 wt. %, a milk fat content of at least about 30 wt. % (dried solids basis), and a combined moisture and wet milk fat content of at least about 70 wt. %, the cheese can be frozen immediately and will still perform satisfactorily when baked on a pizza, under a variety of conditions.

V. Food Products Containing the Mozzarella Variety Cheese

The cheeses that are provided can be incorporated into a wide variety of foodstuffs that can be prepared in applications involving high heat and short cooking times such as described herein. The cheeses, for instance, can be included as an ingredient in a variety of convenience foods, including entrees, snack foods and appetizers.

The term “food stuff” is intended to broadly encompass any type of food to which one can add cheese, particularly those foods that are intended to be heated using high heat for relatively short periods of time (e.g., microwave heating and certain types of convention, infrared and steam heating). Examples of the types of foods into which the provided cheeses can be added, include, but are not limited to: cereal-based products; poultry, beef, pork or seafood entrees; potatoes; vegetables; fruit; candy; and nuts. The cereal-based products can be of diverse types including, for instance, pizzas, burritos, enchiladas, dough-enrobed sandwiches, hand-held foods, breads, bagels, pastries, breaded cheesesticks, and grain-based snack foods (e.g., crackers and pretzels). The cheese can be included with a variety of different forms of potatoes, including, chips, French fries, hash browns, and strings. Likewise, vegetables of various types can be combined with the cheeses that are provided. Exemplary vegetables include, mushrooms, zucchini, peppers (e.g., jalapenos) and cauliflower.

As those skilled in the art will recognize, the foregoing list is simply illustrative and is not intended to an exhaustive list of the types of foods that can be combined with the mozzarella variety cheeses that are provided herein.

The cheeses that are disclosed herein can be combined with foodstuffs such as those just listed using any of a variety of methods. For example, the foodstuff can be dipped in melted cheese. Alternatively, the cheese can be sprinkled or layered onto the foodstuff using conventional food processing equipment. In such processes, the cheese is typically first comminuted to form relatively small pieces of cheese or shredded cheese. Once the cheese has been combined with the foodstuff, the resulting food product can optionally be refrigerated or frozen for future sale or use.

VI. Cooking Methods

Food products such as those just described that contain a cheese such as provided herein are typically cooked under high heat conditions for a relatively short period of time. As noted above, heating conditions of this type can be generated using microwave, infrared, convection and steam heating.

The food products that are provided can be heated in a variety of ways. FIG. 5 provides one example of such a method that utilizes microwave heating. Method 100 shown in this figure involves providing 105 a food product (e.g., a pizza) that contains a microwavable cheese such as provided herein. The cheese has the general protein, fat and moisture composition described above and includes one or more of the melt restriction agents that have been described herein. The cheese can also optionally include one or more additives. The food product is exposed 110 to microwave energy in an amount and for a duration sufficient to heat and melt the cheese, whereby the cheese melts to form a uniform mass of cheese. Melting occurs in accordance with the melt down characteristics described above, wherein the protein, fat and water components of the cheese do not separate during the time period the food product is exposed to the microwave radiation.

The cheeses that are provided give a complete melt-down in microwave ovens having wattages of 400-1000 watts, typically full power microwave ovens of 650-850 watts that are common home microwave ovens. The cheeses perform well over a wide range of microwave cook times, such as from 0.5 to 20 minutes, or 0.5-10 minutes, or 2-5 minutes, which are the typical microwave cook times used to prepare frozen or refrigerated entrees and appetizers.

The following examples are provided to illustrate certain aspects of the mozzarella variety cheeses and methods that are described herein. The examples should not be construed in any way to limit the scope of the invention. In the following examples, unless otherwise indicated, all percentages are by weight.

### EXAMPLE I

This example was conducted to compare the melt characteristics of a standard mozzarella type cheese (control cheese) lacking any melt restriction agent with that of a mozzarella variety cheese that included 2 wt. % starch (test cheese). The composition of the control cheese was 53% moisture, 47% FDB, and 23% protein. The composition of the test cheese was 53.5% moisture, 44% FDB, 24% protein and 2% starch by weight.

Testing of the melt performance of the two cheeses involved separately loading 50 g of diced, frozen control or test cheese into separate 3″ diameter ring that was 1″ deep and then positioning the rings in the center of separate 8″ plates. The ring was then removed, leaving a mound of cheese at the center of the plate (FIGS. 5A and B). The plate was subsequently placed into a Kenmore brand household microwave oven (model #721.68360790) and the cheese cooked at the high setting for 2 minutes.

As can be seen in FIG. 5C, the standard mozzarella cheese melted out to a diameter of approximately 6 inches and became very thin and transparent to the point where the plate became visible through the melted cheese. The test or microwave formulation, retained the 3.5 inch diameter circular shape that it started with. The cheese did, however, melt/fuse together to give a homogeneous mass of cheese that was melted but did not become thin and transparent as occurred with the control cheese (FIG. 5D).

Thus inclusion of 2 wt. % starch gave a cheese with significantly improved melt characteristics as compared to the control cheese under microwave cooking conditions.

### EXAMPLE II

The cheeses utilized in this example were specifically designed for optimum performance on a frozen pizza to be cooked in a microwave. The test cheeses used in this trial had a moisture composition of 46.5-51.5%, a protein level of 17-25% protein, and a fat content of 37.0-43.0% on a dry basis. The cheese included 2% starch to give it improved melting performance in a microwave. The product also had 2% non-fat dry milk, 0.50% natural dairy flavors, and 0.0025% annatto coloring added to give the cheese the visual and organoleptic attributes desired in this application. This test cheese displayed a much more desirable melt appearance on a cooked pizza as compared to a control cheese that had the same composition, with the exception that the starch was omitted. While the test cheese had a very good cheese yield appearance on the cooked pizza, the cheese made without starch had an over melted appearance, with the cheese actually melting off of the pizza such that very little cheese remained on top of the pizza.

It is understood that the examples and embodiments described herein are for illustrative purposes only and that various modifications or changes in light thereof will be suggested to persons skilled in the art and are to be included within the spirit and purview of this application and scope of the appended claims. All publications, patents and patent applications cited herein are hereby incorporated by reference in their entirety for all purposes to the same extent as if each individual publication, patent or patent application were specifically and individually indicated to be so incorporated by reference.

1. A cheese suitable for use in a microwave that has a protein content of about 15-40 wt. %, a fat content of about 10-50 wt. % on a dry basis, and a water content of about 45-60 wt % and comprising one or melt restriction agents selected from the group consisting of a starch, a cellulose agent, a gum, a calcium agent and a phosphate salt, wherein the one or more melt restriction agents are present in a sufficient amount such that the cheese has acceptable melt down characteristics when heated in a microwave.

2. The cheese of claim 1, wherein the one or more melt restriction agents are present in an amount sufficient to prevent separation of the protein, fat and water present in the cheese when heated in a microwave at a high setting in a 650-850 watt microwave for up to about 10 minutes.

3. The cheese of claim 1, wherein at least one of the one or more melt restriction agents is a cellulose agent or a calcium salt.

4. The cheese of claim 1, wherein the one or more melt restriction agents comprise about 1-10 wt. % of the cheese.

5. The cheese of claim 4, wherein the one or more melt restriction agents comprise about 2 wt. % of the cheese.

6. The cheese of claim 1 that is a natural cheese.

7. The cheese of claim 6 that is a soft or semi-soft cheese.

8. The cheese of claim 1 that is an analog or imitation cheese.

9. A food product comprising a foodstuff and a cheese of claim 1.

10. The food product of claim 9, wherein the foodstuff is selected from the group consisting of a frozen pizza, a burrito, an enchilada, an enrobed sandwich and a breaded cheese stick.

11. A process for manufacturing a cheese suitable for use in a microwave, the process comprising incorporating one or more melt restriction agents into the cheese, the one or more melt restriction agents selected from the group consisting of a starch, a cellulose agent, a gum, a calcium agent and a phosphate salt.

12. The process of claim 11, wherein the melt restriction agent is a cellulose agent or a calcium agent and the melt restriction agent is 1-2 wt. % of the cheese.

13. A process of manufacturing a soft or semi-soft cheese suitable for use in a microwave, the process comprising:
a) providing an admixture that comprises a heated mass of soft or semi-soft cheese and one or more melt restriction agents; and
b) shaping and cooling the admixture to form the soft or semi-soft cheese, wherein
the one or more melt restriction agents are selected from the group consisting of a starch, a cellulose agent, a gum, a calcium agent and a phosphate salt, and
the one or more melt restriction agents are present in an amount sufficient such that the cheese has acceptable melt down characteristics when heated in a microwave.

14. The process of claim 13, wherein providing comprises providing a heated mass of soft or semi-soft cheese and mixing the one or more melt restriction agents into the mass to form the admixture.

15. The process of claim 13, wherein providing comprises (i) mixing the one or more melt restriction agents with a cheese curd, and (ii) heating and kneading the mixture of curd and one or more melt restriction agents to form the admixture.

16. The process of claim 13, wherein
the soft or semi-soft cheese that is produced has a protein content of about 15-40 wt. %, a fat content of about 10-50 wt. % on a dry basis, and a water content of about 45-60 wt %; and
the one or more restriction agents are mixed into the mass in an amount that is sufficient to prevent the protein, water and fat in the soft or semi-soft cheese from separating when the cheese is heated at a high setting in a 650-850 watt microwave for up to about 10 minutes.

17. The process of claim 16, wherein the one or more restriction agents are mixed into the mass in an amount that is sufficient to prevent the protein, water and fat present in the soft or semi-soft cheese that is produced from separating when heated at a high setting in a 650-850 watt microwave for between 2-5 minutes.

18. The process of claim 13, wherein at least one of the one or more melt restriction agents is a cellulose agent or a calcium salt.

19. The process of claim 13, wherein the one or more melt restriction agents comprise about 1-10 wt. % of the mozzarella variety cheese.

20. The process of claim 19, wherein the one or more melt restriction agents comprise about 2 wt. % of the mozzarella variety cheese.

21. The process of claim 13, wherein the one or more melt restriction agents comprise a modified food starch.

22. The process of claim 14, wherein mixing is conducted at a temperature in the range of about 145-150° F.

23. The process of claim 14, wherein the one or more melt restriction agents are mixed into the mass at a temperature between about 135-165° F. for about 15-25 minutes.

24. The process of claim 14, wherein mixing comprises mixing a food additive into the heated mass, the food additive being selected from the group consisting of a stabilizer, a colorant, a dairy solid, a cheese powder, a flavor and a non-dairy protein isolate.

25. A process for producing a food product comprising combining a food stuff with a quantity of a cheese of claim 1.

26. A process of cooking a food product that contains cheese, the process comprising:
a) providing a food product that comprises a cheese, wherein the cheese has a protein content of about 15-40 wt. %, a fat content of about 10-50 wt. % on a dry basis, and a water content of about 45-60 wt % and comprises one or more melt restriction agents selected from the group consisting of a starch, a cellulose agent, a gum, a calcium agent and a phosphate salt; and
b) exposing the food product to microwave energy in an amount and for a duration sufficient to heat and melt the cheese, whereby the cheese melts to form a uniform mass of cheese.

27. The method of claim 26, wherein the one or more restriction agents are present in a sufficient amount to prevent the protein, water and fat in the cheese from separating when heated at a high setting in a 650-850 watt microwave for up to about 10 minutes.

28. The method of claim 26, wherein exposing comprises heating the microwavable food product in a microwave oven having a power of 400-1000 watts for 0.5-10 minutes.

29. The method of claim 28, wherein the microwave oven has a power of 650-850 watts and the food product is heated for 2-5 minutes.

30. The method of claim 26, wherein the cheese is a natural cheese.

31. The method of claim 30, wherein the cheese is a soft or semi-soft cheese.

32. The method of claim 26, wherein the cheese is an analog cheese.

33. The method of claim 26, wherein the cheese is a blended cheese.
